(19) United States
(12) Patent Application Publication
(10) Pub. No.: US 2009/0112955 A1
(43) Pub. Date: Apr. 30, 2009

(54) Apparatus and method for performing magnitude detection of arthimetic operations

(75) Inventors: Daniel Kershaw, Cambridge (GB); Mladen Wilder, Cambridge (GB); Dominic Hugo Symes, Cambridge (GB)

Correspondence Address: NIXON & VANDERHYE P.C., 901 N. Glebe Road, 11th Floor, Arlington, VA, 22203-1808, US

(73) Assignee: ARM LIMITED, Cambridge (GB)

(21) Appl. No.: 12/230,831

(22) Filed: Sep. 5, 2008

(30) Foreign Application Priority Data
Oct. 30, 2007 (GB) 0721323.4

(51) Int. Cl. G06F 7/00

(52) U.S. Cl. 708/201

(57) ABSTRACT

An apparatus and method is provided comprising processing circuitry, one or more registers and control circuitry. The control circuitry is configured such that it is responsive to a combined magnitude-detecting arithmetic instruction to control the processing circuitry to perform an arithmetic operation on at least one data element and further to perform a magnitude-detecting operation. The magnitude-detecting operation calculates a magnitude-indicating result providing an indication of a position of a most-significant bit of a magnitude of a result of the arithmetic operation irrespective of whether the most-significant bit position exceeds the data element width of the at least one data element.

### BACKGROUND OF THE INVENTION

1. Field of the Invention

The present invention relates to an apparatus and method for performing magnitude detection for arithmetic operations.

2. Description of the Prior Art

In many data processing applications there is a requirement to perform arithmetic operations and to perform scaling of the arithmetic result. One technique for performing scaling is a block floating point technique. In block floating-point arithmetic a block of data elements is assigned a single exponent rather than each data element having its own exponent. Accordingly, the exponent is typically determined by the data element in the block having the largest magnitude. The block floating point technique reduces the number of bits required to maintain precision in a series of calculations relative to standard floating-point arithmetic. Block floating point calculations are typically performed in software and require scaling of the complete data set following each stage of calculations that may involve a change in magnitude of the data values. The extra instructions required to maintain the data scaling to prevent overflow diminish processing performance in terms of both processing cycles and power consumption.

Accordingly, there is a requirement to improve the efficiency of calculations, such as block floating point calculations, which require both data scaling and arithmetic operations to be performed on data.

### SUMMARY OF THE INVENTION

According to a first aspect, the present invention provides an apparatus for processing data, said apparatus comprising:

processing circuitry for performing data processing operations;

one or more registers for storing data;

control circuitry for controlling said processing circuitry to perform said data processing operations;

wherein said control circuitry is configured such that it is responsive to a combined magnitude-detecting arithmetic instruction to control said processing circuitry to perform an arithmetic operation on at least one data element stored in said one or more of registers and specified by said combined magnitude-detecting arithmetic instruction and to perform a magnitude-detecting operation, wherein said magnitude-detecting operation calculates a magnitude-indicating result providing an indication of a position of a most-significant bit of a magnitude of a result of said arithmetic operation irrespective of whether said most-significant bit position exceeds a data element width of said at least one data element.

The present invention recognises that by providing a single instruction that both performs an arithmetic operation on at least one data element and performs a magnitude-detecting operation to provide an indication of a most-significant bit position of the arithmetic operation irrespective of whether the most-significant bit-position exceeds a data element width of the data element, the program code density for algorithms that perform both arithmetic manipulations and data scaling can be reduced. Providing a special-purpose instruction that both calculates an arithmetic result and facilitates calculation of the position of the most-significant bit of the arithmetic result means that common data manipulations can be performed more efficiently than in known systems which provide separate magnitude-detecting and arithmetic operations. The improved efficiency is achieved a result of fewer instructions being executed, higher throughput and reduced power consumption for the same functionality relative to previously known systems.

The combined magnitude-detecting arithmetic instruction according to the present technique can be implemented in a data processing apparatus comprising only scalar processing circuitry. In one embodiment, the processing circuitry is SIMD processing circuitry arranged to independently perform the arithmetic operation for each of a plurality of SIMD lanes, the combined magnitude-detecting arithmetic instruction identifying at least one SIMD input vector comprising a plurality of data elements on which the arithmetic operation is independently performed to generate a SIMD result vector comprising a respective plurality of result data-elements. This offers improved efficiency since it enables a plurality of magnitude-indicating results corresponding to a respective plurality of result data-elements of a SIMD result vector to be calculated substantially simultaneously.

Although the magnitude-indicating result could indicate the most significant bit for any one of the plurality of data elements within a SIMD result vector, in one embodiment, the magnitude-indicating result provides an indication of a most-significant bit of a greatest of a plurality of magnitudes corresponding to a respective plurality of data elements of the SIMD result vector. This efficiently provides information that allows for scaling of a data set.

The magnitude-indicating result can be provided in a variety of different forms, but in one embodiment, the magnitude-indicating result comprises a SIMD result vector having a plurality of magnitude-indicating result values corresponding respectively to the plurality of SIMD lanes.

The one or more registers of the data processing apparatus which is responsive to the combined magnitude-detecting arithmetic instruction could comprise a single register bank. However, in one embodiment, the one or more registers comprises a SIMD register bank and a scalar register bank. This allows for efficient implementation of the instruction in a SIMD system since the magnitude-indicating result can be stored in the scalar registers.

In one embodiment, the control circuitry controls the processing circuitry to store the result of the SIMD arithmetic operation in the SIMD register bank.

It will be appreciated that the magnitude-indicating result could be stored in any form of memory or in a special-purpose register. However, in one embodiment, the control circuitry controls the processing circuitry to store the magnitude-indicating result in a general purpose register. In one embodiment, the general purpose register is a SIMD register and in another embodiment the general purpose register is a scalar register. In yet a further alternative embodiment, the magnitude-indicating result is stored in a dedicated register.

The arithmetic operation could be any variant of arithmetic operation but in one embodiment, the arithmetic operation is an unsigned arithmetic operation and in another embodiment the arithmetic operation is a signed arithmetic operation.

It will be appreciated that the scaling calculation can be performed whilst the arithmetic operation is being performed. However, in one embodiment, the control circuitry is responsive to the combined magnitude-detecting arithmetic instruction to perform a scaling calculation to scale the at least one data element prior to performing the arithmetic operation in dependence upon a scaling parameter specified by the combined magnitude-detecting arithmetic instruction. This differs from known floating point arithmetic where the scaling operation is typically performed after the arithmetic operation has been performed.

It will be appreciated that the magnitude-indicating result could be calculated based on the unscaled result of the arithmetic operation and then some other scheme could be used to correct the result according to the known effect that the scaling would have. In one embodiment, the control circuitry is responsive to the combined magnitude-detecting arithmetic instruction to calculate the magnitude-indicating result from output of the scaling calculation.

Although the combined magnitude-detecting arithmetic instruction could be any type of instruction, in one embodiment, the combined magnitude-detecting arithmetic instruction is a block floating-point instruction. Providing the combined instruction alleviates a key performance problem (both processing cycles and power) with known block floating point techniques, which require additional instructions to maintain the data scaling.

It will be appreciated that the arithmetic operation could be any one of a number of different arithmetic operations, but in certain embodiments, the arithmetic operation is at least one of a move add, subtract, multiply and multiply-accumulate operation.

It will be appreciated that calculation of the magnitude-indicating result can be performed in any one of a number of ways. In one embodiment, the control circuitry is responsive to the combined magnitude-detecting arithmetic instruction to control the processing circuitry to perform at least one logical operation on at least two of the plurality of data elements of the result of the SIMD arithmetic operation to calculate the magnitude-indicating result, wherein the at least one logical operation is functionally equivalent to a logical OR operation. Calculation of the magnitude-indicating result using at least one logical operation which is functionally equivalent to a logical OR operation is straightforward and inexpensive to implement and involves only a small increase in the complexity of the ALU to achieve the improved efficiency.

Although the at least one logical operation could be performed on complete data elements of the arithmetic result or result vector, in one embodiment, the control circuitry is responsive to the combined magnitude-detecting arithmetic instruction to control the processing circuitry to perform the at least one logical operation on a subset of bits of the at least two data elements. This enables the most-significant bit position to be determined more efficiently by processing a smaller volume of data. In one such embodiment, the subset of bits corresponds to one or more most-significant bits of respective ones of the at least two data elements.

In one embodiment, the control circuitry is responsive to the combined magnitude-detecting arithmetic instruction to control the processing circuitry to detect one or more of the plurality of data elements of the result of the SIMD arithmetic operation having a negative value and to invert the negative value prior to performing the at least one logical operation.

In another embodiment, instead of inverting the negative value, the control circuitry is responsive to the combined magnitude-detecting arithmetic instruction to control the processing circuitry to detect one or more of the plurality of data elements of the result of the SIMD arithmetic operation having a negative value and to negate the negative values prior to performing the at least one logical operation. This enables accurate results for the most-significant bit position to be determined for scaling purposes even for signed data values. Negation and inversion of data values in this way is straightforward to implement.

In one embodiment, the control circuitry is responsive to the combined magnitude-detecting arithmetic instruction to control the processing circuitry to calculate the magnitude-indicating result in dependence upon an operand specified by the combined magnitude-detecting arithmetic instruction. In one such embodiment, the at least one logical operation is dependent upon the operand. This provides additional flexibility in performing the magnitude-detecting operation since, for example the operand can specify a common source and destination within the one or more registers for the at least one logical operation. This also provides a more efficient way of combining the most significant bit position calculations for a large loop by allowing the problem to be broken down into subsets of magnitude calculations for respective groups of result data values.

It will be appreciated that the magnitude-indicating result could be post-processed in any one of a number of different ways to derive the position of the most-significant non-zero bit. However, in one embodiment, the processing circuitry calculates the magnitude-indicating result such that the most-significant non-zero bit is derivable from the magnitude-indicating result by executing one of a Count Leading Zeros instruction and a Count Leading Sign instruction. The use of these pre-existing instructions makes the present technique easy to implement.

It will be appreciated that the magnitude-indicating result could be stored in any one of a number of different ways. However, in one embodiment, the control circuitry controls the processing circuitry to store the magnitude-indicating result in a magnitude-indicating register of the one or more registers.

In one such embodiment, the magnitude-indicating register is specified by a parameter of the combined magnitude-detecting arithmetic instruction. this is convenient to implement and allows for flexibility in specifying an appropriate register.

In one embodiment, the magnitude-indicating register is a general-purpose register. In some such embodiments the general purpose register is one of a SIMD register and a scalar register.

Although the combined magnitude-detecting arithmetic instruction could be included anywhere in program code where an indication of the magnitude of an arithmetic result is required, in one embodiment, the combined magnitude-detecting arithmetic instruction is provided within a loop of instructions such that the magnitude-indicating result is calculated for each iteration of the loop. The efficiency of providing a single instruction to perform an arithmetic instruction and in addition provide an indication of a most-significant bit-position of an arithmetic result is apparent particularly where such operations are likely to be repetitively performed in loops of program code.

In one embodiment, the control circuitry is responsive to the combined magnitude-detecting arithmetic instruction to accumulate the magnitude-indicating result for each iteration of the loop in the magnitude-indicating register. This provides the flexibility to break down a calculation of a most-significant bit-position for a plurality of result values into more manageable sub-calculations.

According to a second aspect, the present invention provides a method for processing data with a data processing apparatus having processing circuitry for performing data processing operations, a one or more registers for storing data and control circuitry for controlling said processing circuitry to perform said data processing operations, said method comprising in response to a combined magnitude-detecting arithmetic instruction:

controlling said processing circuitry to perform an arithmetic operation on at least one data element stored in said one or more registers and specified by said combined magnitude-detecting arithmetic instruction; and

performing a magnitude-detecting operation, wherein said magnitude-detecting operation calculates a magnitude-indicating result providing an indication of a position of a most-significant bit of a magnitude of a result of said arithmetic operation irrespective of whether said most-significant bit position exceeds a data element width of said at least one data element.

According to a third aspect the present invention provides a virtual machine providing an emulation of an apparatus for processing data, said apparatus comprising:

processing circuitry for performing data processing operations;

one or more registers for storing data;

control circuitry for controlling said processing circuitry to perform said data processing operations;

wherein said control circuitry is configured such that it is responsive to a combined magnitude-detecting arithmetic instruction to control said processing circuitry to perform an arithmetic operation on at least one data element stored in said one or more registers and specified by said combined magnitude-detecting arithmetic instruction and to perform a magnitude-detecting operation, wherein said magnitude-detecting operation calculates a magnitude-indicating result providing an indication of a position of a most-significant bit of a magnitude of a result of said arithmetic operation irrespective of whether said most-significant bit position exceeds a data element width of said at least one data element.

The above, and other objects, features and advantages of this invention will be apparent from the following detailed description of illustrative embodiments which is to be read in connection with the accompanying drawings.

### BRIEF DESCRIPTION OF THE DRAWINGS

FIG. 1 schematically illustrates a “butterfly diagram” that illustrates data manipulations performed during computation of the Fast Fourier Transform;

FIG. 2 is a flow chart that schematically illustrates how a known block floating point algorithm performs a Fast Fourier Transform calculation;

FIG. 3 is a flow chart that schematically illustrates a block floating point algorithm according to an embodiment of the present invention;

FIG. 4 is a flow chart that schematically illustrates a block floating point algorithm according to alternative embodiment of the present invention;

FIG. 5 schematically illustrates a data engine for implementing the combined magnitude-detecting arithmetic instruction according to the present technique;

FIG. 6 schematically illustrates the maximum mask circuitry of FIG. 5 in more detail;

FIGS. 7A and 7B schematically illustrate two different sets of circuitry and associated data flow for execution of a combined magnitude-detecting arithmetic instruction according to the present technique; and

FIG. 8 schematically illustrates a virtual machine implementation of the data engine of FIG. 5.

The Fourier Transform is a mathematical operation that that decomposes a function into a continuous spectrum of its frequency components.

A discrete Fourier transform is a Fourier transform corresponding to discrete time signals and is widely employed in signal processing applications to analyse frequencies contained in a sample signal, to solve partial differential equations and to perform other operations such as convolutions. The Fast Fourier Transform (FFT) algorithm is used to compute a discrete Fourier transform.

The discrete Fourier Transform can be described by the following equation:

$$X ( k ) = {\sum }_{n = 0}^{N - 1} x ( n ) {W}_{N}^{kn} 0 \leq k \leq N - 1$$

The transform computation involves calculating the sequence X(k) of complex numbers given N input data values corresponding to the sequence x(n) (usually also assumed to be complex valued) and where W_{N}=e^{-j2π/N} (twiddle factors).

$$X ( k ) = {\sum }_{n = 0}^{( N / 2 ) - 1} [ x ( n ) + {( - 1 )}^{k} x ( n + \frac{N}{2} ) ] {W}_{N}^{kn}$$

Splitting X(k) into even-numbered and odd-numbered samples (process called decimation) gives

$$X ( 2 k ) = {\sum }_{n = 0}^{( N / 2 ) - 1} [ x ( n ) + x ( n + \frac{N}{2} ) ] {W}_{N}^{2 kn} , k = 0 , 1 , 2 … , \frac{N}{2} - 1$$

even samples

$$X ( 2 k + 1 ) = {\sum }_{n = 0}^{( N / 2 ) - 1} [ x ( n ) - x ( n + \frac{N}{2} ) ] {W}_{N}^{2 kn} {W}_{N ,}^{n} k = 0 , 1 , 2 … , \frac{N}{2} - 1$$

odd samples

These equations form the decimation-in frequency FFT algorithm for calculating the discrete Fourier transform. Computation of this N-point DFT via the decimation-in-frequency FFT requires N log₂ N complex additions and (N/2) log₂ N complex multiplications.

To directly evaluate the sums involved in the discrete Fourier transform equations would take the order to N² mathematical operations for a total of N data samples, but the FFT algorithm allows the same result to be computed in only the order of N Log N operations. This simplification is achieved by recursively breaking down a discrete Fourier transform of any composite size N=N₁.N₂ into a plurality of smaller DFTs of sizes N₁ and N₂ and the order of N multiplications by complex roots of unity known as “twiddle factors”. The radix-2 FFT algorithm divides the discrete Fourier transform into two pieces of size N/2 at each step.

### DESCRIPTION OF THE PREFERRED EMBODIMENTS

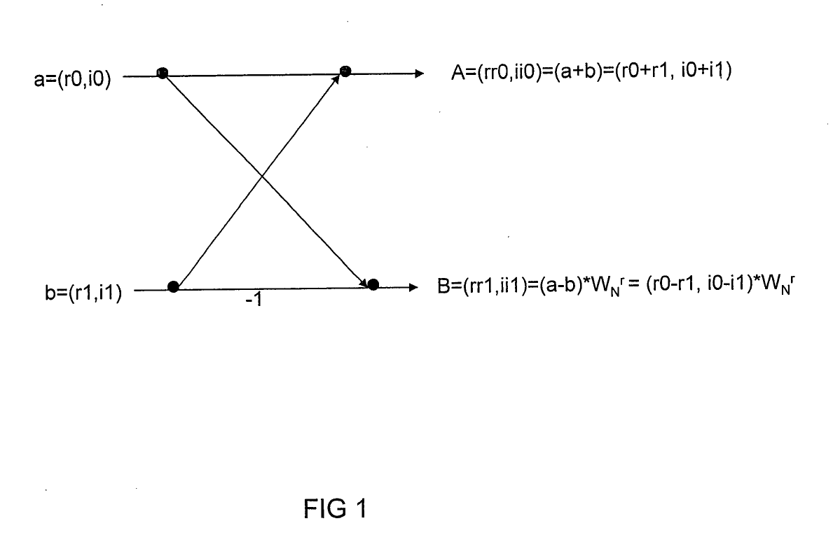

FIG. 1 schematically illustrates a “butterfly diagram” that illustrates data manipulations performed during computation of the Fast Fourier Transform.

The basic computation represented by the butterfly diagram of FIG. 1 is iterated many times during an FFT computation. The butterfly diagram shows two complex input values a and b. The input value a has a real component r0 and an imaginary component i0 whilst the input value b has a real component r1 and an imaginary component i1. The points of the right hand side of the diagram correspond to the outputs of one round of an FFT computation. In particular, the output value A represents a complex sum of the input value a and the input value b. The real part of the output value A is given by the sum of the real components of the input values a and b respectively i.e. r0+r1 whilst the imaginary part is given by the sum of the imaginary parts of a and b i.e. i0+i1. The output value B is also calculated in dependence upon the input values a and b, but this time corresponds to a complex subtraction operation a−b and a multiplication by complex factors known as a “twiddle factor” W. Thus the output value B is given by (a−b)*W and involves a single complex multiplication. The lines with arrows on the butterfly diagram represent data-flow and thus give an indication of the dependencies between the output data values A and B and the input data values a and b. The outputs A and B correspond to outputs of two sub-transforms

The FFT computation involves a plurality of loops of calculation each loop of which involves calculation of a plurality of butterfly diagrams. Thus the output values A and B in FIG. 1 will be supplied as input values to a subsequent round of butterfly calculations. However, between subsequent rounds of butterfly calculations (inner loops of calculations) the result vectors from previously rounds of calculation will typically be rearranged e.g. by performing deinterleave (also denoted herein as “unzip” operations) on the vectors prior to performing the next round of butterfly calculations.

It can be seen from the data flow of the FIG. 1, that each iteration of an inner loop, which involves computation of butterfly diagrams, may cause the bit-width of the data elements to grow. This can be seen by considering the input data elements a and b and noting that the output value A involves an addition operation for each of the real part and the imaginary part of the complex number. Accordingly, the output value A can grow by one bit due to carry-bits from the addition operation. Similarly the output value B involves a complex multiplication between the complex value c=a−b=cᵣ+icᵢ and a complex twiddle factor W=wᵣ+iwᵢ, where cᵣ, wᵣ are the real components and cᵢ, wᵢ are the imaginary components of c and W. Since the complex multiplication c*T=(cᵣ·wᵣ+icᵢ·wᵣ+iwᵢ·cᵣ−cᵢ·wᵢ) involves two addition operations this can result in an output value that has grown by two bits relative to the bit-width of the input data element b.

Thus the addition and multiplication operations cause the data bit width to grow proportionally to the number of iterations of the algorithm in which the butterfly operations are calculated. In general the number of iterations depends on the logarithm (base 2) of the number of input data points. Thus it will be appreciated that an FFT computation typically increases the dynamic range in proportion to the number of elements being processed. Similar considerations apply to other different signal processing algorithms such as the Viterbi algorithm and Turbo decoding algorithms and the present technique is applicable to a range of different algorithms, the FFT algorithm being only one illustrative example.

To cope with the large dynamic range of such computations, a block floating-point arithmetic computation can be performed. In block floating-point arithmetic a block of data is assigned a single exponent rather than each data element having its own exponent. Accordingly, the exponent is typically determined by the data element in the block having the largest magnitude. The use of block floating-point arithmetic obviates the need for complex floating-point multipliers and floating-point adders. Instead, a complex value integer pair is represented with a single scale factor that is typically shared amongst other complex value integer pairs of the block of data. After each stage of the FFT, the largest magnitude output value is detected and the result of the given iteration is scaled to improve the precision of the calculation. The exponent records the number of left or right shifts used to perform the scaling. The conversion from fixed-point to block floating-point representation is typically performed explicitly by the programmer in software.

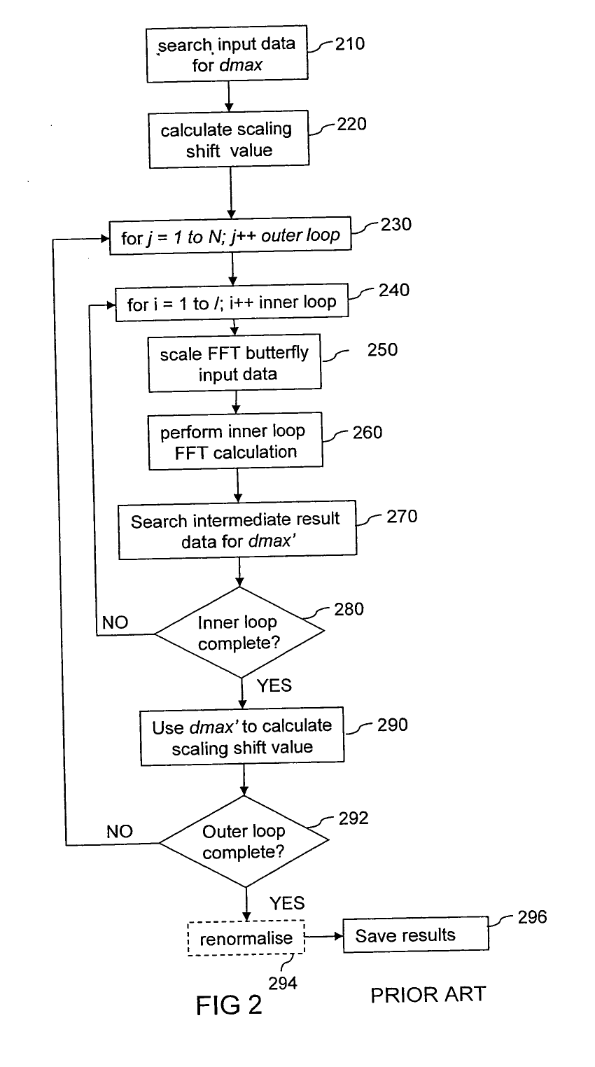

FIG. 2 is a flow chart that schematically illustrates how a known block floating point algorithm performs a calculation. In this particular example the calculation is a Fast Fourier Transform calculation, but it will be appreciated that other different types of calculation could be performed in a similar manner.

The process begins at stage 210 where a block of input data is searched for the value “dmax” corresponding to an input data element having the largest magnitude. Next, at stage 220 a scaling shift value is determined in dependence upon the value of dmax. The process then proceeds to stage 230 the value of j, which is an index for an FFT outer loop, is initialised for j=1 to a value of unity and subsequently incremented on successive loops.

Next, at stage 240, an FFT inner loop index, i, is initialised on the first iteration and subsequently incremented. This inner loop corresponds to performing one complete round of butterfly computations on all of the input data elements. The first stage of the inner loop calculation is stage 250, which involves scaling all of the input data elements by the predetermined scaling shift value. Note that the scaling shift value is determined at stage 220 for the first iteration, but is subsequently determined at stage 290, i.e., at the end of each FFT inner loop. Following the scaling of the input data at stage 250, each data element shares the same exponent value and the same data-element width. Stage 260 corresponds to the body of the FFT inner loop calculation which involves computation of a plurality of butterfly diagrams such as the one illustrated in FIG. 1. Once the FFT butterflies have been calculated, the process proceeds to stage 270 where the intermediate result data (corresponding to outputs A and B in FIG. 1) is searched for a new maximum magnitude “dmax”. Recall that, due to the arithmetic operations involved, each round of the butterfly computations potentially involves an increase in the bit-width of the result data values relative to the input data values. Accordingly, the value of dmax is likely to change from one iteration to the next. Note that dmax is updated for each iteration of the inner loop to generated the updated maximum value dmax′.

Once the value of dmax has been updated at stage 270, the process proceeds to stage 280, where it is determined whether or not the FFT inner loop is complete. If the inner loop is not complete then the process returns to stage 240 where the index i is incremented and the next iteration of the FFT inner loop is performed. If, on the other hand, it is determined at stage 280 that the inner loop is in fact complete then the process proceeds to stage 290 where the current value of dmax′ is used to calculate a new scaling shift value for use in a subsequent FFT outer loop. This scaling shift value is applied at stage 250 to all of the input data prior to performing the next round of FFT inner loop calculations.

After the scaling shift value has been calculated at stage 290, the process proceeds to stage 292, where it is determined whether or not the FFT outer loop is complete. If the outer loop is not complete then the process returns to stage 230 where the counter j is incremented and a data rearrangement is performed prior to the next round of butterfly calculations in the FFT inner loop. If, on the other hand, it is determined at stage 292 that the outer loop is in fact complete then the process proceeds to stage 294 where a data normalisation is performed to take account of the effects of the scaling of the data performed at each stage of the calculation. However, the normalisation stage 294 is optional. Finally, at stage 296, the results of the FFT calculation are saved in memory.

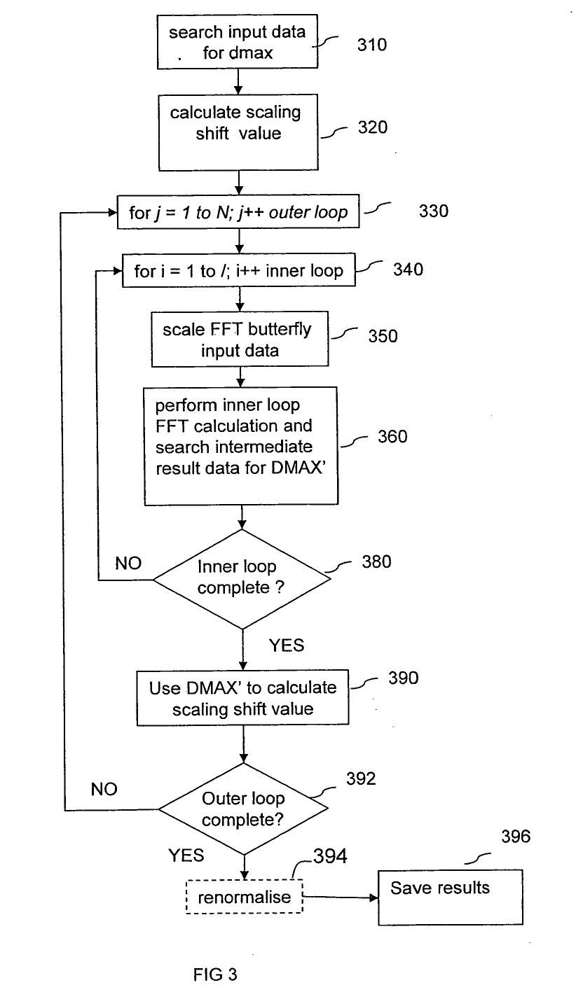

FIG. 3 is a flow chart that schematically illustrates a block floating point algorithm according to an embodiment of the present invention.

Comparison of the flow chart of FIG. 2, which relates to the known technique and the flow chart of FIG. 3 reveals that stages 310, 320, 330, 340, 350, 380, 390, 392, 394 and 396 of FIG. 3 directly parallel stages 210, 220, 230, 240, 250, 280, 290, 292, 294 and 296 respectively in the known technique of FIG. 2. However, one key distinction between the embodiment of FIG. 3 and the known technique of FIG. 2 is that in FIG. 3 the steps of (i) performing the inner loop FFT calculation and (ii) searching the intermediate result data for dmax′ which are performed in distinct stages 260, 270 in FIG. 2 are combined such that they are performed at a single stage 360 in FIG. 3.

The combining of steps (i) and (ii) above is made possible by providing a single program instruction that both performs the required arithmetic operation(s) and provides magnitude information associated with the result of the arithmetic operation(s). In the case of the FFT calculations, the arithmetic operations are as shown in FIG. 1 (i.e. complex addition, subtraction and multiplication operations). Combining the arithmetic calculation step with the dmax′ determination as shown in step 360 of FIG. 3 provides for more efficient implementation of the FFT algorithm dmax′ is calculated as part of the FFT inner loop butterfly evaluation. In FIG. 2, dmax′ must be determined separately (using different program instructions) after the FFT butterflies have been calculated.

Calculation of the scaling shift value from dmax′ at stage 390 of the flow chart of FIG. 3 is performed using a CLS (Count Leading Sign) or CLZ (Count Leading Zeros) instruction. The CLZ instruction returns a number of binary bits before the first binary one in a register value. The CLS instruction returns the position of the non-sign extension bit relative to the most significant bit of the data type containing the CLS's operand.

For example:

MSB_Position=CLS(dmax′);

If, for example the container is 16-bit, and dmax′ is 0001_{—}0000_{—}0000_{—}0000 (in binary), corresponding to +4096 in decimal, CLS will return a value of 3. Considering signed integers, if for example dmax′ is 1111_{—}1000_{—}0000_{—}0000 (in binary), corresponding to −2048 decimal then, CLS will return a value of 5. The scaling shift value is calculated as follows:

Shift_Value=Target_{—}MSB−MSB_Position;

where the target MSB position is where the MSB of the largest scaled datum should lie. The target MSB is chosen such that no overflow can occur. If the Shift is positive then the data is shifted left whereas if the shift is negative the data is shifted to the right.

The result of the calculation at stage 390 is applied at stage 350. Alternative embodiments use the result of the arithmetic operation (stage 360 in this particular example) and then use a different scheme to correct the result according to the known effect that the scaling will have on the result. Note that in alternative arrangements stage 350 and 360 can be swapped so that scaling is perfromed after the FFT inner loop calculation. If the calculation result is a negative value then the most significant bit is determined from an inverted form of the result such that the combined MSB result becomes OR_MSB=Current_OR_MSB|(Result<0 ?˜Result: Result).

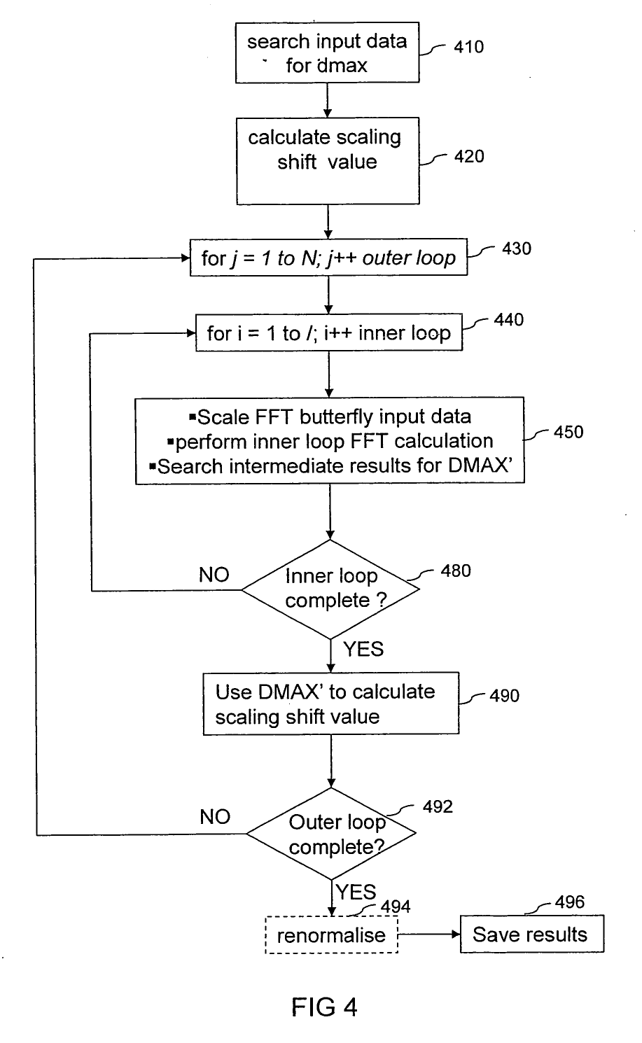

FIG. 4 is a flow chart that schematically illustrates a block floating point algorithm according to alternative embodiment of the present invention.

As explained above, the embodiment of FIG. 3 differs from the known technique of FIG. 2 by combining stages 260 and 270 of FIG. 2 into a single stage 360 in FIG. 3. The embodiment of FIG. 4 combines three separate stages of the FIG. 2 process, i.e. stages 250, 260 and 270, into a single stage 450 so that a single program instruction is provided to: (i) scale all input data for a given iteration of the FFT inner loop; (ii) perform the FFT inner loop butterfly calculations; and (iii) search the intermediate results for dmax′.

The step 450 is adapted such that it takes into account possible overflows that may occur in the calculation prior to the scaling of the input data. Fusing operations 250, 260 and 270 of the known block floating point algorithm of FIG. 2 in this way provides a performance advantage by reducing the number of processing cycles and reducing the power required to perform the FFT calculation by obviating the need for the extra instructions required to perform the scaling of input data for each round of the calculation (relative to FIG. 2 and FIG. 3) and by obviating the need for separate instructions to calculate dmax′ following the arithmetic operations (relative to FIG. 2).

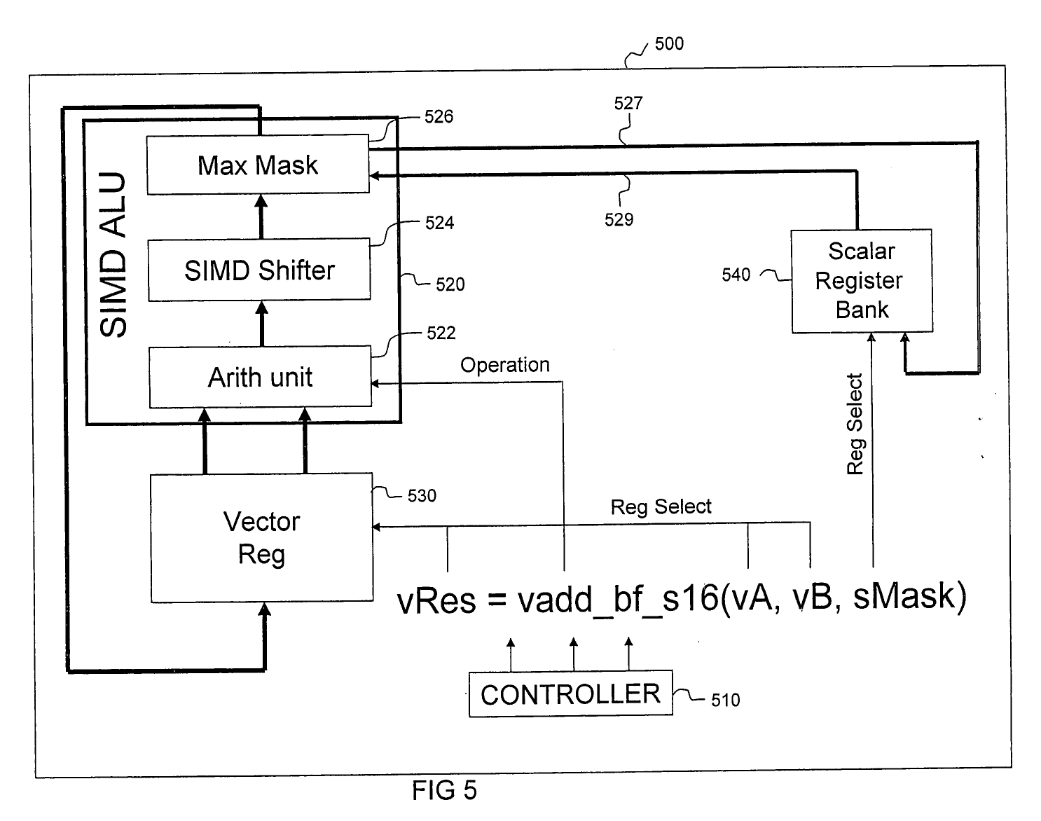

FIG. 5 schematically illustrates a data engine for implementing the combined magnitude-detecting arithmetic instruction according to the present technique. The apparatus comprises a data engine 500 having: a controller 510; a SIMD ALU 520 comprising an arithmetic unit 522, a SIMD shifter 524 and a maximum-value mask 526; a SIMD vector register 530; and a scalar register bank 540.

In the embodiment of FIG. 5, the combined magnitude-detecting arithmetic instruction is a SIMD instruction. SIMD processing involves performing the same operation, be it arithmetic or otherwise, on a plurality of data elements substantially simultaneously. The SIMD processing makes use of so-called “packed vectors”, which are data structures that contain a plurality of basic data-elements. SIMD packed vectors can be used as arguments for SIMD instructions such as arithmetic operations, and the arithmetic operation specified by the SIMD instruction is independently performed on each of the plurality data-elements in the SIMD vector substantially simultaneously. The packed vectors corresponding to SIMD operands are stored in the vector register 530. The SIMD ALU 520 performs arithmetic operations on SIMD vectors and also performs magnitude detection.

One example of a combined magnitude-detecting arithmetic instruction according to the present technique is the “Vres” instruction (see al FIG. 5):—

vRes=vadd_{—}bf_{—}s16(vA, vB, sMask).

This vRes instruction takes two SIMD vector input operands Va and Vb, each packed vector comprising thirty-two 16-bit data elements. A further input parameter “sMask” specifies a 16-bit scalar value corresponding to a scalar register within the scalar register bank 540. In this particular example, the arithmetic operation is an add operation “vadd”. Thus thirty-two independent additions are performed corresponding to the thirty-two data elements of the packed vectors vA and vB.

Now consider how the vRes instruction is implemented by the data engine of FIG. 5. The controller 510 is responsive to the vRes instruction to send control signals to the SIMD processing circuitry 520 and scalar register bank 540 to perform data manipulations as specified by the instruction (in this addition operations and magnitude-detection operations).

The controller 510 is responsive to an instruction corresponding to the vadd “primitive” (or “intrinsic”) shown in FIG. 5 to load constituent data-elements corresponding to SIMD vectors vA and vB into the SIMD vector register 530 (if not already present). The SIMD vA, vB are read from the vector register 530 and supplied directly to the arithmetic unit 520 which performs the SIMD add operation. The results of the SIMD arithmetic operation is output by the arithmetic unit 522 and supplied to the SIMD shifter 524. The SIMD shifter 524 performs the scaling of the data by shifting each data sample in accordance with the appropriate scaling shift value. The scaling shift values are calculated at stage 320 (first iteration) or stage 390 in the flow chart of the FIG. 3 embodiment. Alternatively, the scaling shift values are calculated at stage 420 (first iteration) or stage 490 in the flow chart of the FIG. 3 embodiment. A right-shift corresponds to division by two. As explained above, following each FFT inner loop iteration there is likely to be at least one carry bit from the addition so it is likely that the SIMD shifter 524 will perform at least one right-shift of the data to implement the scaling.

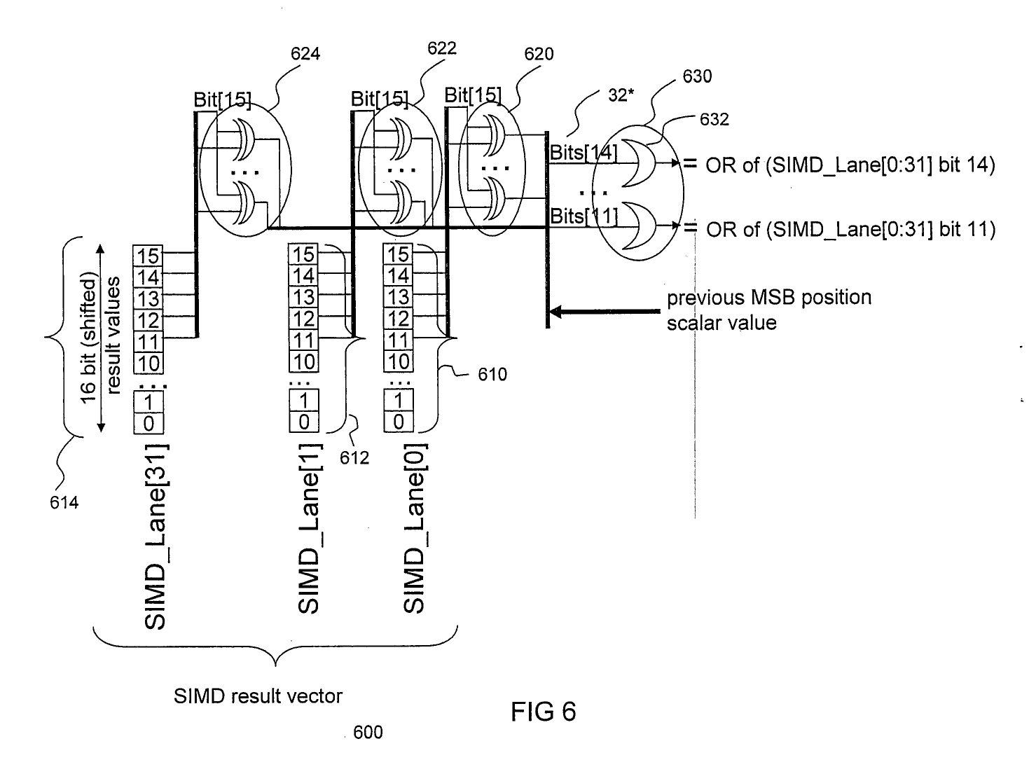

Scaled results output by the SIMD shifter 524 are supplied as input to the maximum mask circuitry 526 within the SIMD ALU 520 where an updated value of the MSB mask is calculated in dependence upon the scaled results. The maximum mask calculation is explained in detail below with reference to FIG. 6. Although in the embodiment of FIG. 5, the scaling is performed during execution of the vRes instruction, in alternative embodiments, the data scaling takes place as data is written to or read from memory in the vector register bank 530.

An updated value for the MSB mask for a current FFT inner loop is supplied via path 527 to the scalar register bank 540 for storage in a scalar register for use in the next iteration of the FFT inner loop. The input parameter sMask of the vRes instruction specifies a scalar register from which the maximum mask circuitry 526 reads a current value of the MSB mask at the beginning of an FFT inner loop iteration and the updated value of the MSB mask is written to the sMask register at the end of the iteration.

In an alternative embodiment to that of FIG. 5, the vRes instruction according the present technique has a further input operand, the further input operand is a scalar value that specifies the shift to be applied to the result of the arithmetic operation. The scalar shift value is a signed value. A positive shift value indicates a right-shift and a negative signed value indicates the left-shift. The data scaling is performed during execution of the instruction. In this alternative embodiment the instruction has the following format:

<arithmetic op>_bf SIMD destination, SIMD operand_{—}1, SIMD operand_{—}2, scalar mag, scalar shift

where _bf qualifies the instruction as being of block floating point type; <arithmetic op> can be add, subtract etc; SIMD indicates that operand_{—}1, operand_{—}2 and destination are SIMD registers. The values “mag” and “shift” are both scalar values. The value “mag” specifies a common source and destination register for an ORing operation used to determine the most-significant-bit. The value “shift” is a signed value that specifies the shift to be applied to the result of the arithmetic operation. Note that in alternative embodiments the scalar shift field is omitted from the instruction and instead of combing the data scaling with the instruction, the data scaling is performed as data is written to or read from memory. The shift performed to implement the scaling of step 250 of FIG. 2 can be associated with a load operation e.g. Reg=vload (address, scalar shift).

The arithmetic unit 522 of the SIMD ALU 520 comprises circuitry adapted to allow for extra carries generated prior to the scaling operation by the arithmetic operation of the vRes instruction.

The maximum mask circuitry 526 of the SIMD ALU 520 is operable to combine the most significant bit position returned by each of the plurality of program instructions of the inner loop of the FFT calculation. Thus a plurality of most significant bit values are combined and the scalar register sMask of the scalar register bank 540 maintains the value corresponding to the highest most significant bit position. Thus at the end of each inner FFT loop iteration the most significant bit overall for the given iteration is read from the scalar register and used for scaling data in the subsequent iteration.

In the embodiment of FIG. 5, a most-significant-bit position is stored in the scalar register sMask of the scalar register bank 540. However, in an alternative embodiment, the register is one of the general purpose registers within the data processing apparatus. In such an alternative embodiment the combined magnitude-detecting arithmetic instruction specifies both a source register and a destination register within the general purpose register bank to perform the operation of maintaining the value of the highest most significant bit position for a round of calculations.

FIG. 6 schematically illustrates the maximum mask circuitry 526 of FIG. 5 in more detail. The maximum mask circuitry comprises a plurality of SIMD lanes 600, each SIMD lane comprising a 16-bit data element 610, 612, 614. In this particular embodiment, there are a total of thirty-two SIMD lanes. However, only three of these lanes 610, 612 and 614 are actually shown for clarity of illustration. The thirty-two 16-bit data elements 600 correspond to entries of the SIMD result vector. A set of XOR gates 624 is associated with SIMD lane 31 and data element 614; a set of XOR gates 622 is associated with SIMD lane 1 and data element 612; and a set of XOR gates 620 is associated with SIMD lane 0. A set of OR gates 630 comprises one gate for each of bits 11 to 14 of the 16-bit data element including an OR gate 632 corresponding to bit 14. The set of OR gates 630 provides an indication of the position of the most significant bit overall for the magnitudes of the 16-bit result values stored in the thirty-two data-element SIMD result vector.

Each 16-bit data element 610, 612, 614 is a signed data value in which bit 15 is the sign-bit. The data values are stored in “2's complement” notation in which negative numbers are represented by the 2's complement of the absolute value and a number is converted from positive to negative or vice versa by computing its 2's complement. To find the 2's complement of a binary number each bit is inverted and the value of 1 is added to the inverted value (bit overflow is ignored). The 2's complement of a negative number is the corresponding positive value. For example consider an 8-bit signed binary representation of the decimal value 5 which is 0000101. Since the most significant bit is a 0 this pattern represents a non-negative value. To convert this positive value to −5 in 2's complement notation each bit is inverted to give the value 1111010 and then a 1 is added to the inverted value to give 11111011. The most significant bit is a 1 so the value represented is negative (−5 in this case).

In the arrangement of FIG. 6, bit 15 is the most significant bit and hence is also the sign-bit. The first stage of calculating the MSB mask involves checking the 16-bit value in each of the thirty-two SIMD lanes to determine whether or not it is negative or positive. For each SIMD lane in which the sign-bit indicates a negative value, the 16-bit data element is inverted. The XOR gates 620, 622, 624 perform the inversion. The data elements for which the most significant bit is a zero (corresponding to positive values) are not inverted.

As shown in FIG. 6, the OR gates 630 are used to perform a logical OR operation (or a functional equivalent thereof). In particular a functional OR operation is performed on bit 14 of each data element for each of the thirty-two SIMD lanes. This is performed by the OR gate 632. Thus if any of the data elements has a non-zero bit in bit-position 14, the OR gate will have an output value of 1. However if all of the SIMD lanes have an empty bit 14 and the output of the OR gate will be zero, which indicates that the most significant bit is in one of the other 14 bit-positions [0, 1, 2 . . . , 13].

The OR gate 632 represents a logical OR of all of the 32-bits corresponding to bit-position 14 of the thirty-two data elements corresponding to the thirty-two SIMD lanes. Although an equivalent functional OR gate could be provided for each of the 15 non-signed bits of the data element, in this particular embodiment, the OR gates 630 are provided for only the four most significant bit positions i.e. bits [11, 12, 13, 14].

Only a subset of the most significant bits need be considered to accurately determine the most significant bit due to the fact that the programmer is able to determine ahead of time how many carry bits a given round of calculations is likely to generate. For example, in the butterfly diagram of FIG. 1, it is clear that up to two carry bits (from the complex multiply) can be generated from each round of calculations. Knowledge of this makes it possible for the programmer to determine in advance the maximum and minimum range within which the most significant bit may be found. In the FIG. 6 example it is known that in the previous round of calculations, the MSB position was determined to be at bit-position 12. It follows that the MSB position for the subsequent round of calculations can be determined from bit-positions 11, 12, 13 and 14 alone. Use of the XOR gates 620, 622, 624 provides a good approximation to a full 2's complement calculation yet is faster and cheaper (e.g. in terms of logic gates) to implement. The approximation becomes even closer as more of the least significant bits are discarded.

In this particular arrangement the most significant bit determination is performed on the SIMD result vector after the scaling shift has been performed (scaling at stage 350 of the flow chart of FIG. 3 or stage 450 of the flow chart of FIG. 4). However, in alternative arrangements, the most-significant-bit determination is performed prior to the scaling shift.

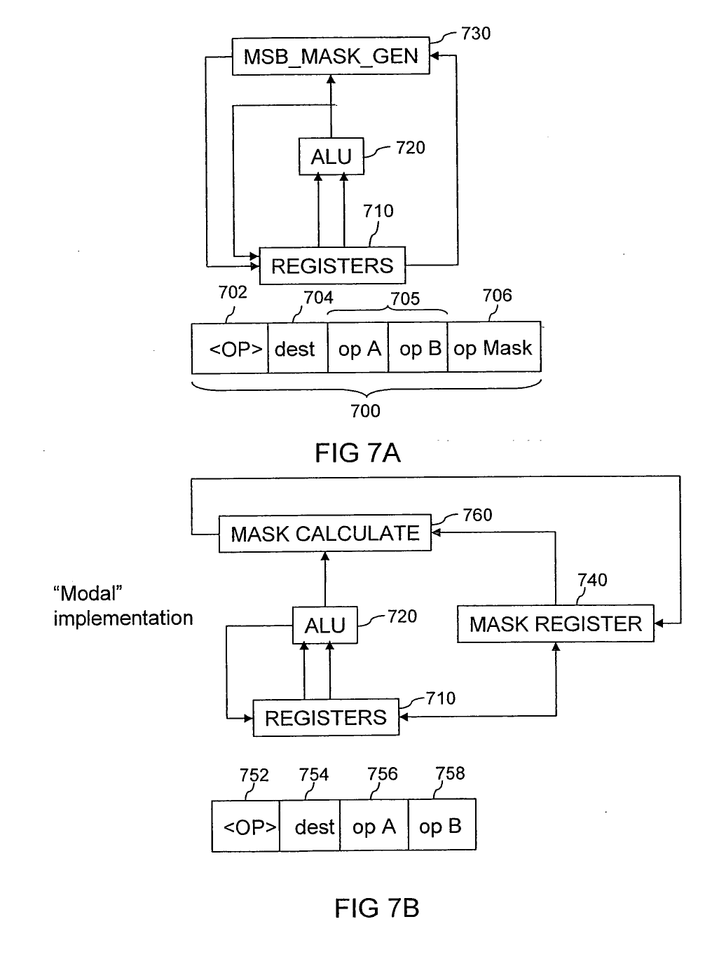

FIGS. 7A and 7B schematically illustrate two different sets of circuitry and associated data flow for execution of a combined magnitude-detecting arithmetic instruction according to the present technique. In particular, FIG. 7A schematically illustrates an instruction in which the maximum value mask is specified as an argument of the instruction. By way of contrast, FIG. 7B schematically illustrates a so-called “modal implementation” of the instruction according to the present technique in which a predetermined mask register is used when the instruction is executed (in this case the instruction does not have an input argument specifying the mask).

The arrangement of FIG. 7A comprises a register bank 710, an ALU 720 and an MSB mask generator 730. An instruction 700 corresponding to the circuitry of FIG. 7 has a total of five fields comprising: an arithmetic operation field 702, a destination register field 704, two operand fields (op A and op B) 705 and an “op Mask” field that specifies a register for storing the most significant bit mask 706. The ALU 720 retrieves the operands op A and op B from the registers 710 during execution of the instruction. Once the arithmetic operation(s) have been performed by the ALU in response to control signals from the controller 510 (see FIG. 5), the MSB mask generator 730 analyses the results vectors to determine the most significant bit position for the plurality of data elements of the packed SIMD results vector and updates the “op mask” value stored in the registers 710.

In the arrangement of FIG. 7B, the instruction comprises four fields (rather than the five fields of the instruction of FIG. 7A). The four fields comprise: an arithmetic operator field 752, a field specifying a destination register 754 and two operand fields (op A and op B) 756, 758. This arrangement differs from that of FIG. 7A in that the instruction does not have a field specifying a register to be used to store the most significant bit mask. Instead, a predetermined mask register 740 is used upon execution of the instruction to maintain a current value providing an indication of the most significant bit position. The value can be read from the mask register at the end of each round of calculations, e.g. at the end of each inner loop of the FFT calculation in order to determine the scaling value for the next iteration.

The mask register 740 is a “modal” register that accumulates the most significant bit position information. The mask register is initialised e.g. to zero before a block of calculations begins. For the first iteration of a loop of calculations, the mask calculation circuitry 760 calculates the mask (i.e. the MSB position) for each executed instruction and stores the current value in the mask register 740. For subsequent iterations, the MSB position determined for a given iteration is combined with the current MSB position stored in the mask register 740 such that the register maintains the highest MSB position. The mask register 740 is then read at the end of a block of calculations to determine the highest-valued MSB that has been reached.

The following is an excerpt of program code than makes use of the combined magnitude-detecting arithmetic instruction according to the present technique. The program code is for a block floating-point radix 2 FFT algorithm.

```
jj=LTOuter;
FFT_LT_OUTER:
  for(j=LTOuter;j>0;j−−){
  vRDTmp = vuzp_m_s16(t_r0,t_r0, 0);
  vIDTmp = vuzp_m_s16(t_i0,t_i0, 0);
  t_r0 = vRDTmp.a[0];
  t_i0 = vIDTmp.a[0];
  jj−−;
  ii=0;
  sMaskR0=(s16)0;
  sMaskR1=(s16)0;
  sMaskI0=(s16)0;
  sMaskI1=(s16)0;
FFT_LT_INNER:
  for(i=0;i<Inner;i++){
  AddLY0 = ii+ii+Ping;
  AddLY1 = ii+ii+Ping+1;
  AddSY0 = ii+Pong;
  AddSY1 = ii+Pong+Points_2;
  ii++;
  r0  = vqrshl_n_s16(vRMem[AddLY0],sShift);
  // Load Data from Vector memory
  r1  = vqrshl_n_s16(vRMem[AddLY1],sShift);
  i0  = vqrshl_n_s16(vIMem[AddLY0],sShift);
  i1 =  vqrshl_n_s16(vIMem[AddLY1],sShift);
  tmpr = vpqsub_m_bf_s16(r0,r1,jj,&sMaskR0); //Butterflies
  rr0  = vpqadd_m_bf_s16(r0,r1,jj,&sMaskR1);
  tmpi = vpqsub_m_bf_s16(i0,i1,jj,&sMaskI0);
  ii0  = vpqadd_m_bf_s16(i0,i1,jj,&sMaskI1);
  tmpqr0 = vqdmull_s16(  tmpr,t_r0); //Multiply by twiddle values
  rr1  = vqrdmlsh_s16(tmpqr0,tmpi,t_i0);
  tmpqi0 = vqdmull_s16(  tmpi,t_r0);
  ii1  = vqrdmlah_s16(tmpqi0,tmpr,t_i0);
  vRMem[AddSY0] = rr0;  //save data where it came from
  vIMem[AddSY0] = ii0;
  vRMem[AddSY1] = rr1;
  vIMem[AddSY1] = ii1;
  }
  Ping \hat{ }= Pong;  //swap ping and pong
  Pong \hat{ }= Ping;
  Ping \hat{ }= Pong;
  sMaskR0 |= sMaskR1;  //combine all the mask values
  sMaskI0 |= sMaskI1;
  sMask  = sMaskR0 | sMaskR1;
  sInScale = clz_s16(sMask);  // find MSBit
  sShift = sInScale-LEADING_ZEROS ; // new shift value
  sExp  = sExp + sShift;  // update exponent running total
}
```

The butterfly diagrams of FIG. 1 are calculated within the FFT inner loop. The notation in the butterfly diagram of FIG. 1 can be correlated with the variables in the above program code. In particular, the inputs to the butterfly computation are (r0, i0), (r1, i1) and the outputs are (rr0, ii0), (rr1, ii1). For example, the following combined magnitude-detecting arithmetic instructions are used to calculate the output A=(rr0, ii0) from the inputs a=(r0, i0) and b=(r1, i1).

rr0=vpqadd_{—}m_{—}bf_{—}s16(r0,r1,jj,&sMaskR1);

ii0=vpqadd_{—}m_{—}bf_{—}s16(i0,i1,jj,&sMaskI1);

The “vpqadd” instructions involve an addition operation and a magnitude-detecting operation whereas the “vpqsub” instructions involve a subtraction operation and a magnitude-detecting operation. The instruction input argument “sMaskR1” is the MSB mask for the real component of the result vector whereas “sMaskI1” is the MSB mask for the imaginary component of the result vector. The masks are combined at the end of the above section of program code (outside the FFT inner loop but within the FFT outer loop). The CLZ instruction is used to determine the position of the most significant bit at the end of each FFT inner loop.

Whilst the above described techniques may be performed by hardware executing a sequence of native instructions which include the above-mentioned instructions, it will be appreciated that in alternative embodiments, such instructions may be executed in a virtual machine environment, where the instructions are native to the virtual machine, but the virtual machine is implemented by software executing on hardware having a different native instruction set. The virtual machine environment may provide a full virtual machine environment emulating execution of a full instruction set or may be partial, e.g. only some instructions, including the instructions of the present technique, are trapped by the hardware and emulated by the partial virtual machine.

More specifically, the above-described combined magnitude-detecting arithmetic instructions may be executed as native instructions to the full or partial virtual machine, with the virtual machine together with its underlying hardware platform operating in combination to provide the processing circuitry described above.

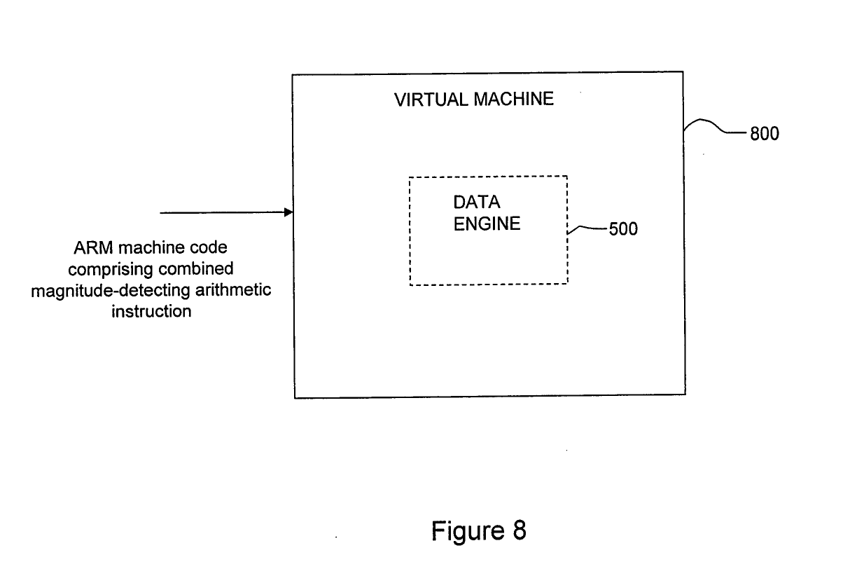

FIG. 8 schematically illustrates a virtual machine implementation of the data engine 500 of FIG. 5. The arrangement comprises a virtual machine 800 arranged to emulate operation of the data engine 500. The virtual machine 800 (e.g. emulating an ARM processor or data engine) is arranged to receive machine code (e.g. ARM machine code) including combined magnitude-detecting arithmetic instructions in accordance with the present technique for which it emulates execution. If a general purpose processor on which the virtual machine 800 is to be run is of sufficiently high performance, then realistic overall processing throughput may be achieved and the advantages of being able to execute an existing code base including combined magnitude-detecting arithmetic instructions in accordance with the present technique may justify the use of a general purpose processor in this way.

Although a particular embodiment has been described herein, it will be appreciated that the invention is not limited thereto and that many modifications and additions thereto may be made within the scope of this invention. For example, various combinations of the features of the following dependent claims could be made with the features of the independent claims without departing from the scope of the present invention.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. Apparatus for processing data, said apparatus comprising:
processing circuitry for performing data processing operations;
one or more registers for storing data;
control circuitry for controlling said processing circuitry to perform said data processing operations;
wherein said control circuitry is configured such that it is responsive to a combined magnitude-detecting arithmetic instruction to control said processing circuitry to perform an arithmetic operation on at least one data element stored in said one or more registers and specified by said combined magnitude-detecting arithmetic instruction and to perform a magnitude-detecting operation, wherein said magnitude-detecting operation calculates a magnitude-indicating result providing an indication of a position of a most-significant bit of a magnitude of a result of said arithmetic operation irrespective of whether said most-significant bit position exceeds a data element width of said at least one data element.

2. Apparatus according to claim 1, wherein said processing circuitry is SIMD processing circuitry arranged to independently perform said arithmetic operation for each of a plurality of SIMD lanes, said combined magnitude-detecting arithmetic instruction identifying at least one SIMD input vector comprising a plurality of data elements on which said arithmetic operation is independently performed to generate a SIMD result vector comprising a respective plurality of result data-elements.

3. Apparatus as claimed in claim 2, wherein said magnitude-indicating result provides an indication of a most-significant bit of a greatest of a plurality of magnitudes corresponding to a respective plurality of data elements of said SIMD result vector.

4. Apparatus as claimed in claim 2, wherein said magnitude-indicating result comprises a SIMD result vector having a plurality of magnitude-indicating result values corresponding respectively to said plurality of SIMD lanes.

5. Apparatus according to claim 2, wherein said one or more registers comprises a SIMD register bank and a scalar register bank.

6. Apparatus according to claim 5, wherein said control circuitry controls said processing circuitry to store said result of said SIMD arithmetic operation in said SIMD register bank.

7. Apparatus according to claim 1, wherein said control circuitry controls said processing circuitry to store said magnitude-indicating result in a general purpose register.

8. Apparatus according to claim 7, wherein said processing circuitry is SIMD processing circuitry arranged to independently perform said arithmetic operation for each of a plurality of SIMD lanes, said combined magnitude-detecting arithmetic instruction identifying at least one SIMD input vector comprising a plurality of data elements on which said arithmetic operation is independently performed to generate a SIMD result vector comprising a respective plurality of result data-elements and wherein said general purpose register is one of a SIMD register and a scalar register.

9. Apparatus according to claim 1, wherein said magnitude-indicating result is stored in a dedicated register.

10. Apparatus according to claim 1, wherein said arithmetic operation is an unsigned arithmetic operation.

11. Apparatus according to claim 1, wherein said arithmetic operation is a signed arithmetic operation.

12. Apparatus according to claim 1, wherein said control circuitry is responsive to said combined magnitude-detecting arithmetic instruction to perform a scaling calculation to scale said at least one data element prior to performing said arithmetic operation in dependence upon a scaling parameter specified by said combined magnitude-detecting arithmetic instruction.

13. Apparatus according to claim 12, wherein said control circuitry is responsive to said combined magnitude-detecting arithmetic instruction to calculate said magnitude-indicating result from output of said scaling calculation.

14. Apparatus according to claim 1, wherein said combined magnitude-detecting arithmetic instruction is a block floating-point instruction.

15. Apparatus according to claim 1, wherein said arithmetic operation is at least one of a move add, subtract, multiply and multiply-accumulate operation.

16. Apparatus according to claim 2, wherein said control circuitry is responsive to said combined magnitude-detecting arithmetic instruction to control said processing circuitry to perform at least one logical operation on at least two of said plurality of data elements of said result of said SIMD arithmetic operation to calculate said magnitude-indicating result, wherein said at least one logical operation is functionally equivalent to a logical OR operation.

17. Apparatus according to claim 16, wherein said control circuitry is responsive to said combined magnitude-detecting arithmetic instruction to control said processing circuitry to perform said at least one logical operation on a subset of bits of said at least two data elements.

18. Apparatus according to claim 17, wherein said subset of bits corresponds to one or more most-significant bits of respective ones of said at least two data elements.

19. Apparatus according to claim 16, wherein said arithmetic operation is a signed arithmetic operation and wherein said control circuitry is responsive to said combined magnitude-detecting arithmetic instruction to control said processing circuitry to detect one or more of said plurality of data elements of said result of said SIMD arithmetic operation having a negative value and to invert said negative value prior to performing said at least one logical operation.

20. Apparatus according to claim 16, wherein said arithmetic operation is a signed arithmetic operation and wherein said control circuitry is responsive to said combined magnitude-detecting arithmetic instruction to control said processing circuitry to detect one or more of said plurality of data elements of said result of said SIMD arithmetic operation having a negative value and to negate said negative values prior to performing said at least one logical operation.

21. Apparatus according to claim 1, wherein said control circuitry is responsive to said combined magnitude-detecting arithmetic instruction to control said processing circuitry to calculate said magnitude-indicating result in dependence on an operand specified by said combined magnitude-detecting arithmetic instruction.

22. Apparatus according to claim 21, wherein said control circuitry is responsive to said combined magnitude-detecting arithmetic instruction to control said processing circuitry to perform at least one logical operation on at least two of said plurality of data elements of said result of said SIMD arithmetic operation to calculate said magnitude-indicating result, wherein said at least one logical operation is functionally equivalent to a logical OR operation and wherein said at least one logical operation is dependent upon said operand.

23. Apparatus according to claim 1, wherein said processing circuitry calculates said magnitude-indicating result such that said most-significant non-zero bit is derivable from said magnitude-indicating result by executing one of a Count Leading Zeros instruction and a Count Leading Sign instruction.

24. Apparatus according to claim 1, wherein control circuitry controls said processing circuitry to store said magnitude-indicating result in a magnitude-indicating register of said one or more registers.

25. Apparatus according to claim 24, wherein said magnitude-indicating register is specified by a parameter of said combined magnitude-detecting arithmetic instruction.

26. Apparatus according to claim 24, wherein said magnitude-indicating register is a general purpose register.

27. Apparatus according to claim 26, wherein said general purpose register is one of a SIMD register and a scalar register.

28. Apparatus according to claim 1, wherein said combined magnitude-detecting arithmetic instruction is provided within a loop of instructions such that said magnitude-indicating result is calculated for each iteration of said loop.

29. Apparatus according to claim 28, wherein said control circuitry is responsive to said combined magnitude-detecting arithmetic instruction to accumulate said magnitude-indicating result for each iteration of said loop in said magnitude-indicating register.

30. Method for processing data with a data processing apparatus having processing circuitry for performing data processing operations, one or more registers for storing data and control circuitry for controlling said processing circuitry to perform said data processing operations, said method comprising in response to a combined magnitude-detecting arithmetic instruction:
controlling said processing circuitry to perform an arithmetic operation on at least one data element stored in said one or more registers and specified by said combined magnitude-detecting arithmetic instruction; and
performing a magnitude-detecting operation, wherein said magnitude-detecting operation calculates a magnitude-indicating result providing an indication of a position of a most-significant bit of a magnitude of a result of said arithmetic operation irrespective of whether said most-significant bit position exceeds a data element width of said at least one data element.

31. A computer program stored on a computer-readable medium operable when executed on a data processing apparatus to cause said data processing apparatus to operate in accordance with the method of claim 30, said computer program comprising at least on combined magnitude-detecting arithmetic instruction.

32. A virtual machine providing an emulation of an apparatus for processing data, said apparatus comprising:
processing circuitry for performing data processing operations;
one or more registers for storing data;
control circuitry for controlling said processing circuitry to perform said data processing operations;
wherein said control circuitry is configured such that it is responsive to a combined magnitude-detecting arithmetic instruction to control said processing circuitry to perform an arithmetic operation on at least one data element stored in said one or more registers and specified by said combined magnitude-detecting arithmetic instruction and to perform a magnitude-detecting operation, wherein said magnitude-detecting operation calculates a magnitude-indicating result providing an indication of a position of a most-significant bit of a magnitude of a result of said arithmetic operation irrespective of whether said most-significant bit position exceeds a data element width of said at least one data element.
